(19) United States
(12) Patent Application Publication
(10) Pub. No.: US 2005/0028034 A1
(43) Pub. Date: Feb. 3, 2005

(54) Fault diagnosis, repair and upgrades using the acoustic channel

(76) Inventors: Alexander Gantman, Poway, CA (US); Gregory G. Rose, Concord (AU)

Correspondence Address: Qualcomm Incorporated;Patents Department, 5775 Morehouse Drive, San Diego, CA, 92121-1714, US

(21) Appl. No.: 10/888,102

(22) Filed: Jul. 9, 2004

Related U.S. Application Data
(60) Provisional application No. 60/490,701, filed on Jul. 28, 2003.

(51) Int. Cl. G06F 11/00

(52) U.S. Cl. 714/27

(57) ABSTRACT

An acoustic channel is used for fault diagnosis, repair, and upgrades. Remote diagnosis uses self-test data encoded into sound waves. Repair data and upgrades are also encoded and transmitted as sound waves.

### CROSS-REFERENCE TO RELATED APPLICATIONS

The present Application for Patent claims priority to Provisional Application No. 60/490,701 entitled “Fault Diagnosis, Repair and Upgrades Using the Acoustic Channel” filed Jul. 28, 2003, and assigned to the assignee hereof and hereby expressly incorporated by reference herein.

This application is also related to the following, all of which are assigned to the same assignee of this application.

Co-pending U.S. application Ser. No. 10/356,144 filed Jan. 30, 2003 and entitled “Wireless Communication Using Sound.”

Co-pending U.S. application Ser. No. 10/356,425 filed Jan. 30, 2003 and entitled “Communication Using Audible Tones.”

Co-pending Provisional U.S. Application No. 60/413,981 filed Sep. 25, 2002 and entitled “Data Communication Through Acoustic Channels and Compression.”

### BACKGROUND

I. Field of Invention

The invention generally relates to electronic devices and more particularly to diagnosis of electronic devices using sound.

II. Description of the Related Art

A growth in the consumer market has led to a growth in electronic products for homes, offices and other establishments. With advances in technology, the electronic products are also becoming more sophisticated with greater or improved capabilities and functions. However, these additional or improved functions generally require a more complex hardware, software and/or hardware implementation, which increases the chances for errors and malfunction to occur.

When an electronic product malfunctions, users typically must physically take the product in for service, causing significant inconvenience, especially if the product is large. Alternatively, users may call a technician for an on-site or on-location visit, which can also be inconvenient as well as expensive. While some products may have a self-test functionality, they lack the means for communicating the test data to a technician. As a result, users must still take the product to a technician or the technician must make an on-site visit for diagnosis and possible repair.

Accordingly, there is a need for a more convenient and efficient way to diagnose and repair products.

### SUMMARY

Embodiments disclosed herein address the above stated needs by providing a method for security in a data processing system.

In one aspect, apparatus for use in remote diagnosis comprises a self test unit configured to perform a self test and to generate test data; a converter configured to encode the test data into sound waves; and an audio output unit coupled to the converter and configured to output sound waves encoded with test data for diagnosis. The apparatus may further comprise an audio input unit configured to receive sound waves encoded with repair data. The apparatus may also further comprise an actuator configured to receive a signal that activates the self-test unit.

In another aspect, a method for use in remote diagnosis comprises generating self test data; encoding the self test data into sound waves; and outputting sound waves encoded with self test data for diagnosis. The method may further comprises receiving sound waves encoded with repair data. The method may also further comprise receiving a signal that activates the generating of self-test data.

In still another aspect, apparatus for use in remote diagnosis comprises means for generating self test data; means for encoding the self test data into sound waves; and means for outputting sound waves encoded with self test data for diagnosis. The apparatus may further comprise means for receiving sound waves encoded with repair data. The apparatus may also further comprise means for receiving a signal that activates the means for generating the self test data.

In a further aspect, a machine readable medium comprises a set of codes for generating self test data; a set of codes for encoding the self test data into sound waves; and a set of codes for outputting sound waves encoded with self test data for diagnosis. The medium may further comprise a set of codes for receiving sound waves encoded with repair data. The medium may also further comprise a set of codes for receiving a signal that activates the set of codes for generating the self test data.

In still a further aspect, apparatus for remote fault diagnosis comprises an audio input unit configured to receive sound waves encoded with self test data; and a converter coupled to the audio input unit and configured to recover the self test data for performing fault diagnosis. In the apparatus, the converter may be configured to encode repair data into sound waves; and the apparatus further comprises a processor configured to generate the repair data based on the self test data; and an audio output unit configured to output sound waves encoded with repair data.

In yet another aspect, a method for remote fault diagnosis comprises receiving sound waves encoded with self test data; and recovering the self test data for performing fault diagnosis. The method may further comprise generating repair data based on the self test data; encoding repair data into sound waves; and outputting sound waves encoded with repair data.

In yet a further aspect, apparatus for remote fault diagnosis comprises means for receiving sound waves encoded with self test data; and means for recovering the self test data for performing fault diagnosis. The apparatus may further comprise means for generating repair data based on the self test data; means for encoding repair data into sound waves; and means for outputting sound waves encoded with repair data.

In still another aspect, a machine readable medium for remote fault diagnosis comprises a set of codes for receiving sound waves encoded with self test data; and a set of codes for recovering the self test data for performing fault diagnosis. The medium may further comprise a set of codes for generating repair data based on the self test data; a set of codes for encoding repair data into sound waves; and a set of codes for outputting sound waves encoded with repair data.

### BRIEF DESCRIPTION OF THE DRAWINGS

Various embodiments will be described in detail with reference to the following drawings in which like reference numerals refer to like elements, wherein:

FIG. 1 shows an example system for diagnosis, repair and/or upgrade by the acoustic channel;

FIG. 2 is a block diagram of an example consumer product;

FIG. 3 shows an example procedure for remote diagnosis of a consumer product;

FIG. 4 is a block diagram of another example consumer product;

FIG. 5 shows another example procedure for remote diagnosis and/or repair of a consumer product;

FIG. 6 shows an example converter for encoding data into sound waves;

FIG. 7 shows an example converter for recovering data from sound waves;

FIG. 8 shows an example transmitting device that sends digital data using audible sound;

FIG. 9 shows an example receiving device for receiving data sent by the transmitting device of FIG. 8;

FIG. 10 shows an example transmitting process; and

FIG. 11 shows an example receiving process.

### DETAILED DESCRIPTION

Generally, embodiments disclosed allow consumer products having self-test functionality to be diagnosed, repaired and/or upgraded using sound. In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may be shown in detail in order not to obscure the embodiments.

Also, it is noted that the embodiments may be described as a process which is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

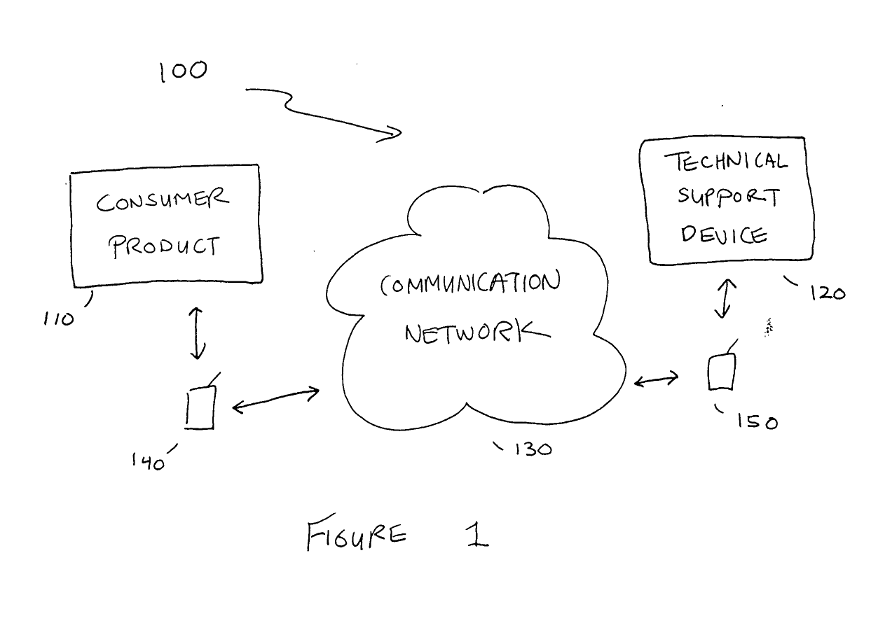

FIG. 1 shows an example system 100 for diagnosis, repair and/or upgrade by the acoustic channel. System 100 comprises a consumer product 110, a technical support device 120, a communication network 130, a communication device 140 and a communication device 150. Consumer product 110 can be one of various devices having a self-test functionality. Examples of consumer product 110 includes, but is not limited to, a refrigerator, microwave oven, television set, audio system, alarm system, copier and printer. Communication device 140 and 150 may be a wireless or non-wireless communication device such as, but is not limited to, a desktop phone or a wireless phone. Accordingly, communication network 130 may be a wireless communication network, a non-wireless communication network or a combination of both. Technical support device 120 may be located with the manufacture of consumer product 110 or may be located off site from the manufacturer. Alternatively, technical support device 120 may be a service center for products of one or more manufacturers. Also, communication device 150 may be implemented within technical support device 120.

Consumer product 110 comprises a self-test functionality that can be activated by a user. When a problem such as a malfunction occurs or for help, the user may contact technical support device using communication devices 140 and 150 through communication network 130. User then activates the self-test functionality. The test results from the self-test is output as sound signals and can be sent to technical support device 120 through communication 130 using communication device 140. Technical support device 120 comprises an audio input unit for receiving the test results for diagnosis from consumer device 110 through communication 130 using communication device 150. After diagnosis, a technician may be sent for on-location repair of the malfunction. However, if the problem can be resolved by data input such as by software and/or firmware correction, data may be sent back as sound through communication network 130 using communication devices 140 and 150 to consumer product 110. Therefore, a remote diagnosis and/or repair of consumer product 110 may be achieved using sound. In addition, software and/or hardware upgrades may also be sent from technical support device 120 to consumer product 110 in the same manner.

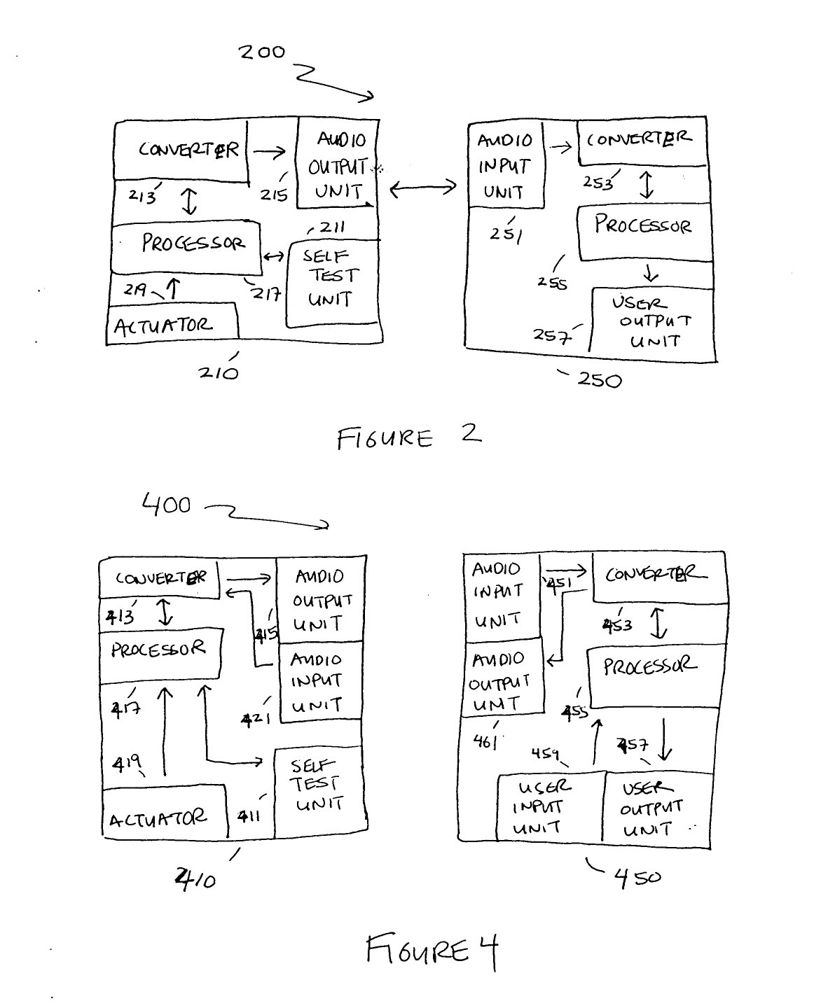

FIG. 2 is a block diagram of system 200 showing an embodiment of a consumer product 210 and a technical support device 250. Consumer product 210 comprises a self-test unit 211 configured to perform a self test and to generate test data, a converter 213 configured to encode the test data into sound waves, an audio output unit 215 configured to output the sound waves encoded with test data for diagnosis, and a processor 217 configured to control one or more of self test unit 211, converter 213 and audio output unit 215. Consumer product 210 may also comprise an activator or actuator 219 configured to receive a signal that activates the self-test unit. Actuator 219 may be, but is not limited to, a switch, a push-button, a toggle switch, a dial or sound activated device.

Technical support device 250 comprises an audio input unit 251 configured to receive sound waves encoded with test data, a converter 253 configured to recover the test data and a processor 255 configured to process the test data and to control one or more of audio input unit 251 and converter 253. Technical support device 250 may also comprise a user output unit 257 configure to output test data to technicians. User output unit 257 may be, but is not limited to, a display, a printout or an audio output unit. Based on test data output from user output unit 257, technicians may diagnose and resolve problems for users of consumer products. Here, a technician refers to a specialist, a troubleshooter or a person who's duty is to resolve technical problems.

FIG. 3 shows a procedure 300 for remote diagnosis of a consumer product. When a consumer product malfunctions, user of the product may contact a technician (310) using communication devices 140 and 150. For example, user may call a technician by phone. When a technician receives notification of a problem (315), technician prepares to receive test data (320) through technical support device 150. After contact, the user activates the self-test function (325) of consumer product using actuator 219. A self-test is then performed and test data is generated (330) by self-test unit 211. Here, self-test unit 211 performs the self-test after receiving a signal by actuator 219 to activate the self-test unit. The test data is encoded into sound waves (335) by converter 213 and the sound waves encoded with test data is output (340) through audio output unit 215.

When test data is output as sound waves, the user uses communication device 140 to send the sound waves encoded with test data to the technician through communication network 130. Also, when test data is sent through communication network 130, the technician uses communication device 150 to allow technical support device to receive the sound waves encoded with test data. Accordingly, sound waves encoded with test data is received (345) through audio input unit 251. The test data is recovered from the sound waves (350) by converter 253 and output (355) to the technicians through user output unit 255. Based on the test data, the technician may then diagnose and resolve the problem (360). If necessary after diagnosis, a technician may be sent for on-site repair for resolving the problem or the user may take the consumer product to a technician for repair.

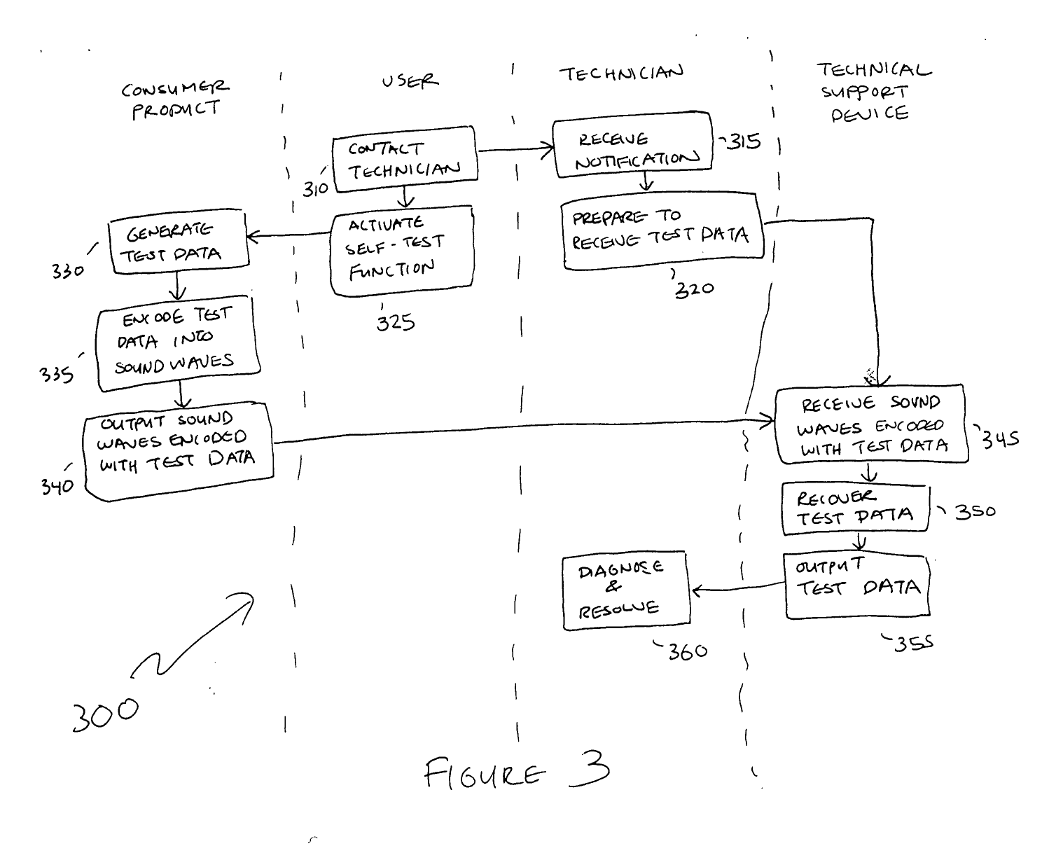

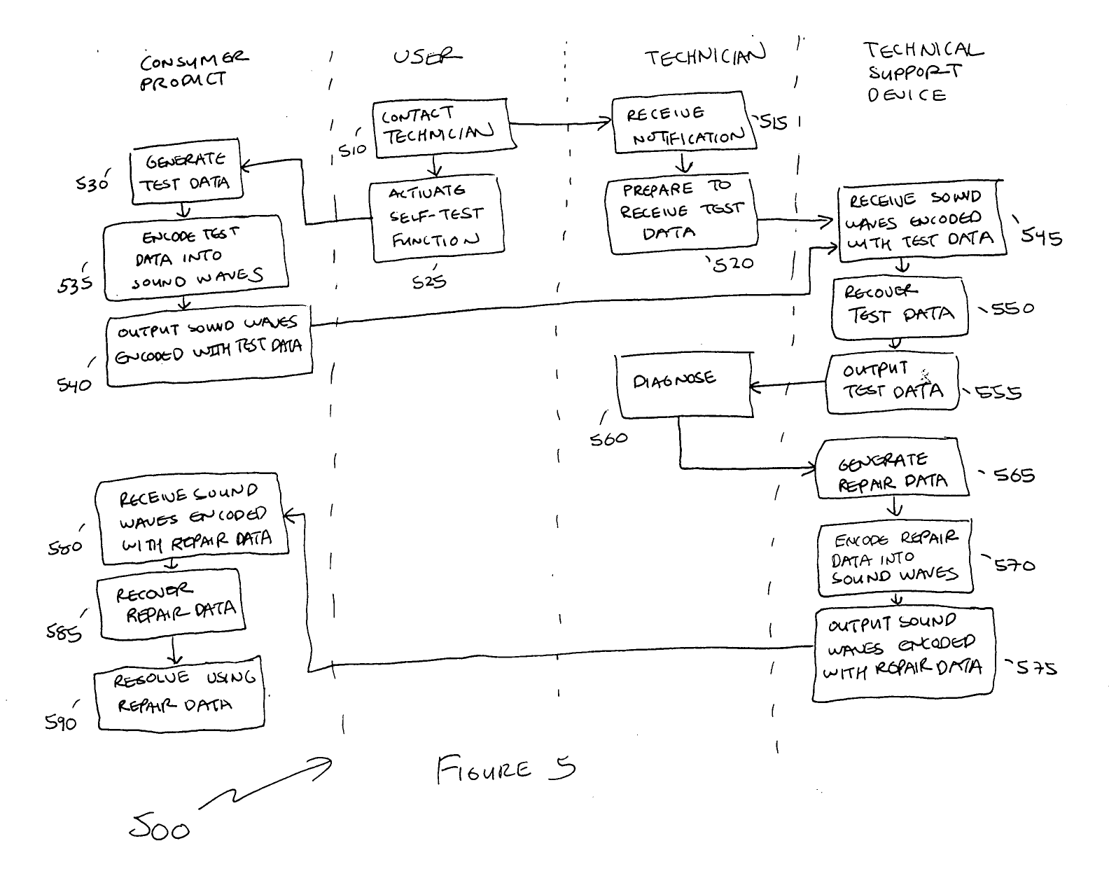

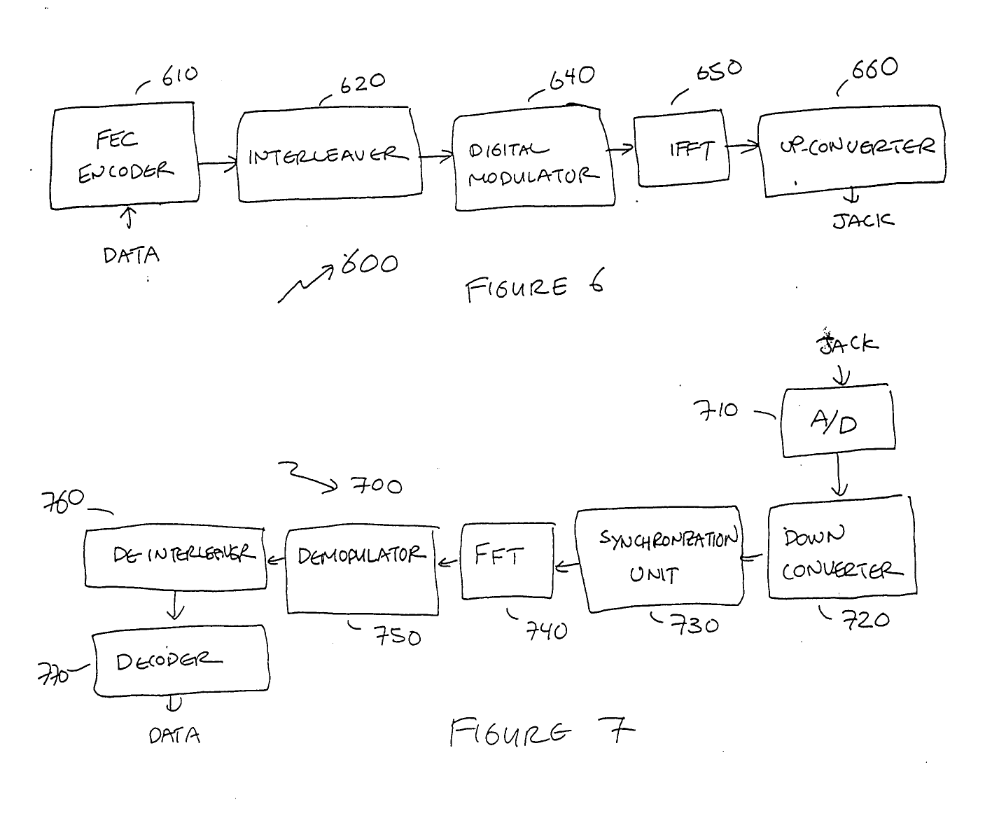

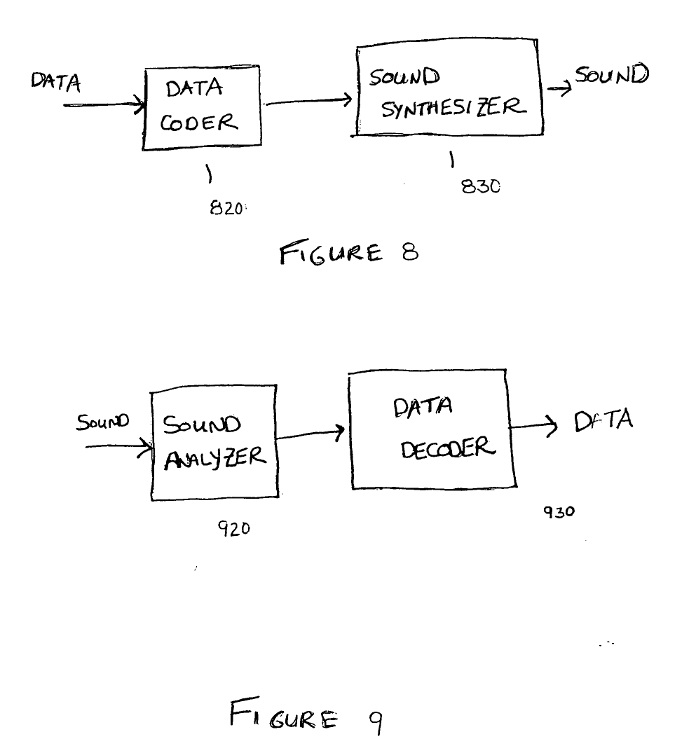

FIG. 4 is a block diagram of system 400 showing another embodiment of a consumer product 410 and technical support device 450. Consumer product 410 is similar to consumer product 210 and comprises a self-test unit 411, a converter 413, an audio output unit 415, a processor 417 and an actuator 419 corresponding to self-test unit 211, converter 213, audio output unit 215, processor 217 and actuator 219. However, consumer 410 further comprises an audio input unit 221 configured to receive a data for repair. Technical support device 450 is also similar to technical support device 450 and comprises an audio input unit 451, a converter 453 configured to recover the test data, a processor 455 and a user output unit 457 corresponding to audio input unit 251, converter 253, processor 255 and user output unit 257. However, technical support device 450 further comprises a user input unit 459 configured to receive user input and an audio output unit 461 configured to output data for repair. Here, a technician may diagnose a problem and may enter user input to send data back to consumer product 410 for resolving problems for users of consumer products. Alternatively, processor 417 may perform diagnosis and may send data back to consumer product 410 to resolve problems.

FIG. 5 shows a procedure 500 for remote diagnosis of a consumer product. When a consumer product malfunctions, user of the product may contact a technician (510) using communication devices 140 and 150. For example, user may call a technician by phone. When a technician receives notification of a problem (515), technician prepares to receive test data (520) through technical support device 120. After contact, the user activates the self-test function (525) of consumer product using actuator 419. A self-test is then performed and test data is generated (530) by self-test unit 411. Here, self-test unit 411 performs the self-test after receiving a signal by actuator 419 to activate the self-test unit. The test data is encoded into sound waves (535) by converter 413 and the sound waves encoded with test data is output (540) through audio output unit 415.

When test data is output as sound waves, the user uses communication device 140 to send the sound waves encoded with test data to the technician through communication network 130. Also, when test data is sent through communication network 130, the technician uses communication device 150 to allow technical support device to receive the sound waves encoded with test data. Accordingly, sound waves encoded with test data is received (545) through audio input unit 451. The test data is recovered from the sound waves (550) by converter 453 and may be output (555) to the technicians through user output unit 455. Based on the test data, the technician may then diagnose the problem (560).

If repair is possible by software and/or firmware, technician sends data back for repair through technical support device 450. Namely, the technician enters user input through user input unit 459 such that data for repair is generated (565) by processor 457. The data for repair is converted into sound waves (570) by converter 453 and output as sound waves encoded with repair data (575) through audio output unit 415. The sound waves encoded with repair data is send and received in the same manner as sound waves encoded with test data. Therefore, consumer product receives sound waves encoded with repair data (580) through audio input unit 221. The repair data is then recovered (585) by converter 423 and the problem is resolved using the repair data (590). Here, processor 417 may perform repairs. If necessary after diagnosis, a technician may still be sent for on-site repair for resolving the problem or the user may take the consumer product to a technician for repair.

While any known technique may be used in systems 200 and 400 to encode digital data such as the test data or repair data into sound waves, or to recover digital data from sound waves, a multi-carrier (MC) modulation may be used to encode digital data into sound waves and MC demodulation is used to recover the digital data from sound waves. Particularly, in one embodiment, the access code and/or password is converted to and from audio waves. Audio waves having frequencies in the range of approximately 1 kHz to 3 kHz are used such that a standard speaker can be used for the audio output unit and a standard microphone may be used for the audio input unit. A multi-carrier system is described in co-pending U.S. application Ser. No. 10/356,144 and co-pending U.S. application Ser. No. 10/356,425.

FIG. 6 shows an example first conversion unit 600 for encoding digital data into outgoing multiple sound wave carriers. First conversion unit 600 may comprise a forward error correction (FEC) element 610, an interleaver 620, a digital modulator 640, an inverse fast fourier transform (IFFT) element 650 and an up-converter 660. First conversion unit 600 may also comprise a preamble generator (not shown) configured to generate synchronization preambles. The synchronization preambles are transmitted to help a receiving device in synchronizing to the frequency, time and phase of the received signal. FEC element 610 is configured to encode digital data bit sequence to be transmitted. The FEC encoded bits are then interleaved into code symbols by interleaver 620. The code symbols are modulated into multiple audio wave carriers by digital modulator 640 and inverse fast fourier transformed by IFFT element 650 to generate analog signals, called MC symbols. The MC symbols are then up converted by up-converter 660 for output as audio waves encoded with digital data through audio output unit. Thus, first conversion unit 600 may be implemented in converters 213 and 253 for encoding test data or repair data into sound waves.

FIG. 7 shows an example second conversion unit 700 corresponding to first conversion unit 600 for processing multiple audio waves encoded with digital data information. Generally, digital data is recovered from the multiple audio waves in a process that is inverse to the process for transmitting the data as audio waves. Second conversion unit 700 may comprise an analog to digital (A/D) converter 710 configured to convert the incoming multiple audio waves from an analog to a digital signal, a down-converter 720 configured to down convert the digital signal, a synchronization unit 730 configured to synchronize to the carrier in phase and arrival time of incoming data sequence, a fast fourier transform (FFT) 740 configured to recover the MC symbols, a demodulator 750 configured to demodulate the MC symbols, a de-interleaver 760 configured to de-interleave the demodulated data, and a decoder 770 configured to decode the de-interleaved data using one of various known techniques and recover the digital data. Thus, second conversion unit 700 may be implemented in converters 213 and 453 for recovering a repair data or test data from sound waves.

In another embodiment, an LUT may be used for converting digital data into sound waves. Such a technique is disclosed in co-pending Provisional U.S. Application No. 60/413,981. Generally, digital data may be converted or mapped into at least one sound parameter used to synthesize sound. Sound is then generated using the sound parameter(s). When recovering data, sound parameter(s) are extracted from the received sound and the relevant sound parameter(s) are converted back into digital data. To convert between data and parameter(s), a set of relationship is predefined such that certain parameter(s) having a predetermined characteristic and/or value or range of values represent a predetermined pattern of binary bits.

More specifically, FIG. 8 shows one embodiment of a transmitting device 800 that sends digital data using audible sound and FIG. 9 shows one embodiment of a receiving device 900 that receives the data sent by the transmitting device 800. The transmitting device 800 comprises a data coder 820 that converts the received digital data into at least one sound parameter and a sound synthesizer 830 that generates sound using the sound parameter(s) from the data coder 820. The receiving device 900 comprises a sound decoder 910 that extracts sound parameters from the received sound and a data decoder 930 that converts the relevant parameter(s) extracted by the sound decoder 910 into digital data. Thus, transmitting device 800 may be implemented in converters 213 and 253 for encoding test data or repair data into sound waves. Similarly, the receiving device 900 may be implemented in converters 213 and 453 for recovering a repair data or test data from sound waves.

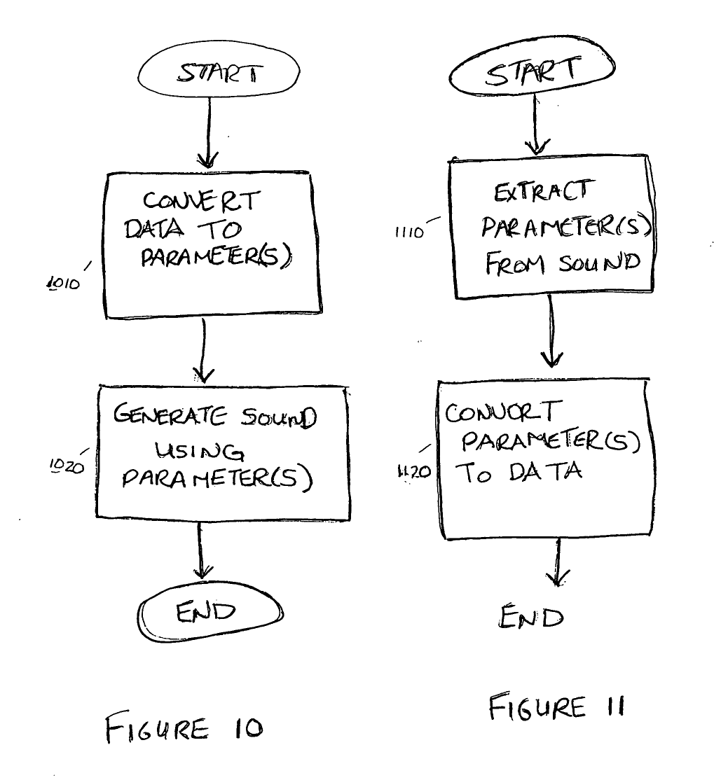

FIG. 10 shows a transmitting process 1000 for sending digital data using audible sound and FIG. 11 shows a receiving process 1100 for receiving digital data using audible sound. Digital data is received and converted/mapped into at least one parameter (block 1000) that is used in synthesizing sound. Based on the sound parameter(s), sound is then generated (block 1000). When sound is received, the sound parameter(s) are extracted (block 1100) and converted back into digital data (block 1100). More particularly, a set of relationship may be predefined to convert and/or map the digital data to at least one sound parameter, hereinafter called data symbol. Based on the set of relationship, the data coder 820 and decoder 830 convert and/or map the data to and from parameter(s), respectively.

In one embodiment, one or both the transmitting device 800 and the receiving device 900 may be implemented with a look-up table (LUT) (not shown) that predefines a relationship between parameter(s) and bit patterns. LUT may be implemented separately or as a part of the data coder 820 and/or data decoder 930, respectively. The LUT may then be used by the data coder 820 to convert received digital data into at least one parameter. Similarly, the LUT may be used by the data decoder 930 to convert the parameter(s) extracted by the sound decoder 910 into digital data.

Table 1 below is an example of a LUT for converting between digital data and one parameter, where A, B, C and/or D may be a pitch value or a range of pitch values.

| PITCH | BIT PATTERN |
|---|---|
| A | 00 |
| B | 01 |
| C | 10 |
| D | 11 |

As shown, the LUT defines a relationship between bit patterns and pitch values, which is often a parameter used in synthesizing sound. Accordingly, to transmit a digital data of “010001,” for example, the bit pattern would be converted to pitch values of “BAB” based on the LUT. The pitch values “BAB” that represent the digital data would then be used to generate sound in three consecutive frame, the pitch being constant over one frame. To receive the digital data, the pitch values “BAB” can be extracted from the received sound and converted to the bit pattern of “010001” based on the LUT.

Note that for purposes of explanation, one parameter is used in the LUT. However, any number of parameters, as allowed by the system, may be used in defining a relationship between parameters and bit patterns. Also, each parameter may be defined to have more or less than the four values or range of values that correspond to different bit patterns.

Accordingly, test data and/or repair data may be encoded into and recovered from sound, thereby allowing remote diagnosis and/or repair. For example, an owner or a malfunctioning microwave oven can call up the manufacturer's support line, hold the phone up to the microwave oven, press the self-test actuator, and the manufacturer would have the results of the test. By remote diagnosis and/or repair, the inconvenience of taking a product to a technician is eliminated. While a user may mail the product to a technician, the user must still prepare the product for mailing, must often take the product down to a post office, and then wait. Such inconvenience may also be eliminated.

Moreover, for consumer products having an audio input unit and for technical support device having an audio output, software and/or firmware for upgrade may be sent over a communication network in the same manner as repair data is sent. Therefore, remote software and/or firmware upgrade, including calibration and configuration, is also made possible. In addition, even if a technician makes an on-site visit, the system as describe above may be used for installation, diagnosis, repair and/or reinstallation of consumer devices. Furthermore, because a standard speaker and/or microphone may be used, the system can easily be implemented without incurring significant cost.

Finally, embodiments may be implemented by hardware, software, firmware, middleware, microcode, or any combination thereof. When implemented in software, firmware, middleware or microcode, the program code or code segments to perform the necessary tasks may be stored in a machine readable medium such as storage medium (not shown). A processor such as processor 217, 257, 417 or 457 may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In addition, one or more elements 211, 213, 215, 217 and 219 of consumer product 210 may be implemented together. Similarly, one or more elements 411, 413, 415, 417, 419 and 421 of consumer product 410 may be implemented together. One or more elements 251, 253, 255 and 257 of technical support device 250 may be implemented together. One or more elements 451, 453, 455, 457, 459 and 461 of technical support device 450 may be implemented together. For example, processor 217 and self test unit 211 may be implemented together. Processor 417 and self test unit 411 may be implemented together.

Moreover, FFT 740, demodulator 750, de-interleaver 760 and decoder 770 of conversion unit 700 may be implemented as software stored in a storage medium, and performed by a processor. Also, although first conversion unit 600 and second conversion unit 700 are described to be implemented together in converter 213, 253, 413 and 453, first and second conversion units may be implemented separately into two converters. Moreover, it should be apparent to those skilled in the art that the elements of consumer product 210 or 410 may be rearranged without affecting the operation of the token. Similarly, the elements of technical support device 250 or 450 may be rearranged without affecting the operation of the verifier device. In addition, one or more of processor 217

Therefore, the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

1. Apparatus for use in remote diagnosis comprising:
a self test unit configured to perform a self test and to generate test data;
a converter configured to encode the test data into sound waves; and
an audio output unit coupled to the converter and configured to output sound waves encoded with test data for diagnosis.

2. The apparatus of claim 1, further comprising:
an audio input unit configured to receive sound waves encoded with repair data.

3. The apparatus of claim 1, further comprising:
an actuator configured to receive a signal that activates the self-test unit.

4. A method for use in remote diagnosis comprising:
generating self test data;
encoding the self test data into sound waves; and
outputting sound waves encoded with self test data for diagnosis.

5. The method of claim 4, further comprising:
receiving sound waves encoded with repair data.

6. The method of claim 4, further comprising:
receiving a signal that activates the generating of self-test data.

7. Apparatus for use in remote diagnosis comprising:
means for generating self test data;
means for encoding the self test data into sound waves; and
means for outputting sound waves encoded with self test data for diagnosis.

8. The apparatus of claim 7, further comprising:
means for receiving sound waves encoded with repair data.

9. The apparatus of claim 7, further comprising:
means for receiving a signal that activates the means for generating the self test data.

10. Machine readable medium for use in remote diagnosis comprising:
a set of codes for generating self test data;
a set of codes for encoding the self test data into sound waves; and
a set of codes for outputting sound waves encoded with self test data for diagnosis.

11. The medium of claim 10, further comprising:
a set of codes for receiving sound waves encoded with repair data.

12. The medium of claim 10, further comprising:
a set of codes for receiving a signal that activates the set of codes for generating the self test data.

13. Apparatus for remote fault diagnosis comprising:
an audio input unit configured to receive sound waves encoded with self test data; and
a converter coupled to the audio input unit and configured to recover the self test data for performing fault diagnosis.

14. The apparatus of claim 13, wherein the converter is configured to encode repair data into sound waves; and the apparatus further comprises:
a processor configured to generate the repair data based on the self test data; and
an audio output unit configured to output sound waves encoded with repair data.

15. A method for remote fault diagnosis comprising:
receiving sound waves encoded with self test data; and
recovering the self test data for performing fault diagnosis.

16. The method of claim 15, further comprising:
generating repair data based on the self test data;
encoding repair data into sound waves; and
outputting sound waves encoded with repair data.

17. Apparatus for remote fault diagnosis comprising:
means for receiving sound waves encoded with self test data; and
means for recovering the self test data for performing fault diagnosis.

18. The apparatus of claim 17, further comprising:
means for generating repair data based on the self test data;
means for encoding repair data into sound waves; and
means for outputting sound waves encoded with repair data.

19. A machine readable medium for remote fault diagnosis comprising:
a set of codes for receiving sound waves encoded with self test data; and
a set of codes for recovering the self test data for performing fault diagnosis.

20. The medium of claim 19, further comprising:
a set of codes for generating repair data based on the self test data;
a set of codes for encoding repair data into sound waves; and
a set of codes for outputting sound waves encoded with repair data.
